(19) United States
(12) Patent Application Publication
(10) Pub. No.: US 2020/0090248 A1
(43) Pub. Date: Mar. 19, 2020

(54) NETWORK COMPUTING SYSTEM FOR DETERMINING INTEREST LEVELS FOR CONSUMABLE ITEMS

(71) Applicant: Uber Technologies, Inc., San Francisco, CA (US)

(72) Inventors: Zhen Zeng, San Francisco, CA (US); Martin Ken Iyoya, San Francisco, CA (US); Brion McDonough, San Francisco, CA (US)

(21) Appl. No.: 16/539,452

(22) Filed: Aug. 13, 2019

Related U.S. Application Data
(60) Provisional application No. 62/730,976, filed on Sep. 13, 2018.

(51) Int. Cl. G06Q 30/06; G06Q 30/02; G06Q 50/30; G06Q 50/12

(52) U.S. Cl. CPC G06Q 30/0631; G06Q 30/0205; G06Q 50/12; G06Q 50/30; G06Q 30/0639

(57) ABSTRACT

A network computing system can publish a collection of interactive items for a given geographical region. The network computing system can detect interactions with the interactive items by a population of users, where each interaction is associated with a location of the user, one or more food items identified for selection by the interaction, and one or more food preparation sources selected by the interaction. Additionally, the network computing system can determine an interest level for a food item or type at one or more sub-regions of the geographic region, based on at least a portion of the detected interactions.

### RELATED APPLICATIONS

This application claims benefit of priority to provisional U.S. Patent Application No. 62/730,976, filed Sep. 13, 2018; the aforementioned priority application being hereby incorporated by reference in its entirety.

### TECHNICAL FIELD

Examples described herein relate to a network computing system for determining interest levels for consumable items.

### BACKGROUND

The technology underlying many on-demand network services (e.g., ride-sharing, food-delivery, etc.) is complex and demanding. For example, on-demand network services generally utilize distributed network computing architectures to aggregate and process information from numerous sources, while at the same time, providing highly-responsive and relevant output to user requests and input. To fulfill service requests (e.g., requests generated from end users to receive service, service requests generated by predefined service events, etc.), an on-demand network service typically coordinates numerous workflows, some of which may depend on other workflows. Moreover, in some cases, the workflows may be implemented in-part using user devices and other third-party services.

Numerous on-demand services exist to offer users a variety of services: transportation, shipping, food delivery, groceries, pet sitting, mobilized task force and others. Typically, on-demand services leverage resources available through mobile devices, such as wireless (e.g., cellular telephony) devices, which offer developers a platform that can access sensors and other resources available through the mobile device. Many on-demand services include dedicated applications (sometimes referred to as “apps”) to communicate with a network service through which an on-demand service is offered.

### BRIEF DESCRIPTION OF THE DRAWINGS

FIG. 1 illustrates a network computing system to determine interest levels for menu items, according to one or more examples.

FIG. 2 illustrates an example method for determining interest levels for menu items amongst a population of users.

FIG. 3A and FIG. 3B illustrate alternative map interface that indicates interest levels for food items or types in a given geographic region, according to one or more examples.

FIG. 4 illustrates a computer system on which one or more embodiments can be implemented.

FIG. 5 is a block diagram illustrating an example consumer device for use with examples as described.

### DETAILED DESCRIPTION

A network computer system determines interest level and predicts trends amongst users of a population for food items and types of food (e.g., Italian). The network computer system recognizes that in a given geographic region, the interest level of users for food items and types of food can be fluid. In some examples, the network computer system can recommend, to one or more users, alternative menu items for restaurants based on the determined interest levels of users that are located near the restaurant or will be near the restaurant during a certain timeframe. The alternative food items can be for food items of a different type. For example, the network computer system can recommend Peruvian menu items for an Italian restaurant, to enable the Italian restaurant to prepare food items that are of interest and trending.

The network computer system can determine an interest level of users for specific food items and/or types or genre of food items, by detecting the interactions of the users concerning the interactive menu. Based on the interactions, the network computer system can generate a heat map or other content (e.g., visual, textual, interactive content, etc.) which references the interest level to a sub-region or area of the geographic region. The network computer system can also identify areas or sub-regions where food items of interest are undersupplied, such as a result of a trend for a particular type of food.

According to examples, an uptrend, in a given period of time, for a particular food item or food type can be identified by interactions of users that search for and view corresponding menu items, without the interactions becoming conversions (e.g., purchases or transactions for the viewed food items). Such interactions can be probative of user interest, but the non-conversion can indicate, for example, that the cost is too high or that the food preparation time for the restaurant that provides the identified food item is high. In this way, the network computer system can identify a frequently searched or viewed food item to be trending popular and also undersupplied when there is a disproportionate number of conversions for the food items.

Examples provide for a network computing system to publish a collection of interactive menu items for a given geographical region, where each menu item includes one or multiple food items that can be prepared by a corresponding food preparation source (e.g., supplier) of the geographical region. The network computing system can detect interactions with the interactive menu items by a population of users of the geographical region, where each interaction is associated with a location of the user, one or more food items identified for selection by the interaction, and one or more food preparation sources selected by the interaction. Additionally, the network computing system can determine an interest level for one or more food items and/or one or more food types at one or more sub-regions of the geographic region based on at least a portion of the detected interactions. The network computing system can generate a content that indicates the interest level for a food item or type at one or more sub-regions of the geographic region.

As used herein, a client device refers to devices corresponding to desktop computers, cellular devices or smartphones, wearable devices, laptop computers, tablet devices, television (IP Television), etc., that can provide network connectivity and processing resources for communicating with the system over a network.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein can generally require the use of computing devices, including processing and memory resources. For example, one or more embodiments described herein may be implemented, in whole or in part, on computing devices such as servers, desktop computers, cellular or smartphones, tablets, wearable electronic devices, laptop computers, printers, digital picture frames, network equipment (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program.

### System Description

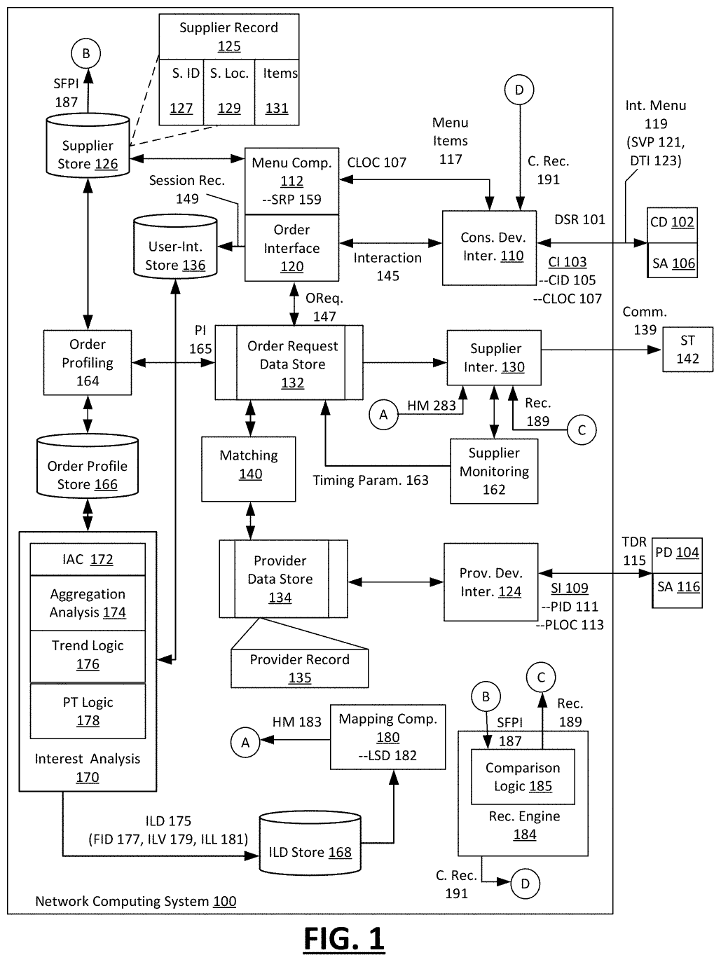

FIG. 1 illustrates a network computing system to determine interest levels for menu items, according to one or more examples. In particular, a network computing system 100 can implement processes to determine the interest level of menu items, in connection with a delivery service which enables users to request menu items for delivery. With respect to examples as described, the system 100 can be implemented on a server, on a combination of servers, and/or on a distributed set of computing devices which communicate over a network such as the Internet. Still further, some examples provide for the network computing system 100 to be distributed using one or more servers and/or mobile devices. In some variations, the network computing system 100 is implemented as part of, or in connection with a network system, where, for example, operators use service vehicles to provide transport-related services between locations. In variations, the network computing system 100 may be implemented using mobile devices of users, including transport providers and consumers, with the individual devices executing a corresponding service application that causes the computing device to operate as an information inlet and/or outlet for the network computing system 100.

In some examples, the system 100 implements a network platform, in connection with applications that run on mobile devices of the population of users. The users can include those who order items from the delivery service through their respective computing device (“requesting consumer”), as well as those who receive items from the delivery service as part of a group (collectively termed “consumers” in examples as described). The users can also include suppliers, which can include, for example, operators of restaurants, stores which provide prepared foods, and food preparers (e.g., independent chefs operating in professional kitchens). The providers can include individuals and fleet operators who provide transport service, such as in connection with delivery orders.

With reference to an example of FIG. 1, the system 100 includes a consumer device interface 110, an order interface 120, a provider device interface 124, a supplier interface 130, a matching component 140, and an interest analysis sub-system (“IASS”) 170. Additionally, the system 100 can include one or multiple data stores which maintain information about consumers, suppliers, and providers. As described by some examples, the system 100 can be implemented in connection with a delivery service which enables consumers in a geographic region to request food items from suppliers (e.g., restaurants) for delivery to their respective locations.

As described by various examples, the IASS 170 can determine an interest level for menu items that are made available by suppliers for a population of users in a given geographic region. In examples, the IASS 170 can make determinations of interest level for various food items that are made available for selection to consumers through an interactive menu, which the system 100 can publish on computing devices of the consumers. Additionally, the system 100 may include one or more components that utilize interest level determinations of the IASS 170.

The consumer device interface 110 includes or performs processes that run on the network-side of the system 100 to establish communication channels with individual devices of consumers. The consumers may operate mobile devices (represented in FIG. 1 by the consumer device 104) on which a corresponding service application 106 may execute. The consumers may operate respective service applications 106 to request delivery services, and in some variations, other types of transport-related services, such as human transport between a start location (or pickup location) and a destination (or drop-off). The service application 106 may obtain its current location 107 by interfacing with a satellite receiver or other location-aware resource of the consumer device 102.

According to some examples, the provider device 104 initiates communications with the system 100 using the service application 116. The service application 116 may correspond to a program (e.g., a set of instructions or code) that is downloaded and stored on the mobile device 104 of the transport provider. The transport provider can launch the service application 116 to utilize the system 100 to receive transport delivery requests 115, and/or another type of service requests (e.g., transport requests). The transport provider may operate a service vehicle to fulfill a transport delivery request 115. Once the communication channel is established by the provider device 104 using the service application 116, the provider device 104 may repeatedly or continuously communicate service information 109 to the network computing system 100. The service information 109 may include the provider's identifier 111, as well as the provider's current location 113, which may be determined by the service application interfacing with a satellite receiver of the provider device 104.

The provider device interface 124 includes or performs processes that run on the network-side of the system 100 to establish communication channels with individual devices of transport providers. For example, the device interface 110 can establish secure sockets with different types of mobile devices, which transport providers of the system 100 can utilize when delivering orders and providing other services using their respective vehicles. In some examples, the transport providers operate mobile devices (represented in FIG. 1 by the mobile device 104) on which a corresponding service application 116 may be operated. Among other functionality, the service application 116 can automate operations which include indicating the availability of the transport provider to provide service, communicate location information to enable the system 100 to monitor the location of the transport provider's vehicle, receive information from the system 100 to facilitate the transport provider in receiving order requests and fulfilling order requests, as well as communicating information to the system 100 for various purposes.

The system 100 may include an active provider data store 134 that maintains records 135 that associate individual providers with their respective current location 113 and service status. By way of example, each transport provider may start a shift by operating the service application 116 (e.g., opening the application on the provider's device 104), and then toggling a state feature provided by the service application 116 to ‘on duty’. The service application 116 communicates the activation of the state feature to the system 100 via the provider device interface 124. The provider device interface 124 processes the service information 109 received from individual transport providers. For each transport provider, the provider device interface 124 extracts and stores the current location 113 of the provider device 104 with the provider's identifier 111 in the provider status store 134. As the transport provider's location changes (e.g., with the movement of the transport provider's vehicle), subsequent communications from the provider device 104 via the provider device interface 124 can be used to update the provider status store 134. In this way, the service data store 134 may reflect the most current location of each transport provider.

In some examples, the consumer device interface 110 and the provider device interface 124 can each include or use an application programming interface (API), such as an externally facing API, to communicate data with the consumer and provider devices 102, 104, respectively. By providing the externally facing API, the system 100 can establish secure communication channels via secure access channels over the network through any number of methods, such as web-based forms, programmatic access via RESTful APIs, Simple Object Access Protocol (SOAP), remote procedure call (RPC), scripting access, etc.

The supplier interface 130 may correspond to a programmatic interface that transmits order requests from consumers to a terminal of a supplier (shown as supplier terminal 142). The context of food delivery, the supplier interface 130 transmits delivery orders to a computer system (e.g., reservation ordering system, point-of-sale device, dedicated take-out terminal, etc.) of the supplier. In some examples, the supplier may operate a mobile device on which a service application for suppliers is provided, to receive order requests from the system 100. The supplier may access the system 100 via, for example, a website or application interface (e.g., supplier service application) to accept order requests, as well as to provide information as to the preparation status of an order request. Additionally, the supplier may access the system 100 to provide menus or descriptions (including text and images) of available items for delivery.

The system 100 may maintain a supplier profile store 126, which includes a record 125 for each supplier. Each supplier record 125 may associate a respective supplier with an account identifier 127, as well as a supplier location 129 and a set of deliverable items 131 provided by that supplier. The supplier may specify the deliverable items 131 via the supplier interface 130. The deliverable items 131 may be provided as an electronic document, or combination of records provided by the supplier, which can be retrievable and rendered on a consumer device 102 in the form of, for example, an interactive menu. By way of example, the supplier items 131 can be in the form of a restaurant menu, or items for a restaurant menu.

According to examples, the consumer device 102 may generate a delivery service request 101 to the consumer device interface 110 when, for example, the service application 106 is launched. The delivery service request 101 may include, or otherwise be transmitted with consumer information 103, which may include an account identifier 105, as well as the current location 107 of the consumer device. In response to the delivery service request 101 being transmitted, the order interface 120 can initiate the order session for the consumer. In some examples, when the order session is initiated, the menu component 112 uses the current location 107 of the consumer to retrieve menu items 117, representing a selection of the supplier's deliverable items 131, from the supplier profile store 126. The menu component 112 can also utilize a service range parameter 159 to select menu items 117 from the supplier's store. The service range parameter 159 can define a distance (e.g., travel distance) from the service location of the desired order request, from which available suppliers may be made available to the consumer for the purpose of delivery orders. Accordingly, the menu component 112 may use the service range parameter 159 in selecting suppliers, from which menu items 117 can be selected.

The consumer device interface 110 may communicate interactive menu 119 to the consumer device 102, via the service application 106, based on the menu items 117 that match to the current location 107 of the consumer. As described with some examples below, the interactive menu 119 may also communicate one or more service value parameters 121, indicating a charge or consideration which the consumer will incur for receiving delivery of a requested item from the supplier.

In other examples, the interactive menu 119 may communicate delivery time information 123, indicating a duration between the time the user completes an order request and the predicted time until which the corresponding delivery request arrives at the location. As described with other examples, the delivery time information 123 can be determined based in part on an estimated duration for the supplier to prepare a given item or the items of a delivery order. Additionally, the delivery time information 123 can include an estimate duration for transporting a delivery order from a location of the supplier to the consumer. As described with some examples, the delivery time information 123 can be determined from monitoring order requests (e.g. using monitoring component 162) provided to the supplier in preceding time intervals, models (e.g., stochastic models) that use relevant historical information for the supplier and/or predicted transport times.

The consumer can browse through the interactive menu 119 to view a list of suppliers, and view information about food items which each available supplier has available for use with a delivery service of system 100. For example, the consumer can perform searches of the interactive menu 119 using terms that relate to a food item (e.g., burger), a food type or genre, a price range or other designation. The consumer's search can also include location information, which may be automatically provided by the service application. In other variations, the consumer may provide the location information in order to search food items that are offered with a delivery service at another location.

The menu content can respond to the searches by rendering matching menu items, sorted by relevance, supplier and/or other parameter. The service application 106 may enable the user to interact with the menu on the consumer device 102, in order to select items for a delivery order. Upon making a selection, the service application 106 may cause the consumer device 102 to transmit a selection input. The order interface 120 can process the selection input by placing the selected menu item in a checkout queue for the consumer. The consumer may next signal completion of an order. The order interface 120 can place an order request 147 in the order request data store 132. The order request 147 can identify each item the requester selected, the supplier the item was selected from, and the delivery location for the order request.

In some implementations, the order interface 120 can generate a session record 149 to store as part of a user-interaction store 136. The session record 149 can identify information about a current order session of the consumer, including the account identifier 105 and current location 107. The session record 149 can also identify the menu item that was the subject of an interaction (e.g., search, viewing) by the consumer during the session, such that the interaction is associated with a supplier and/or associated food item of the respective menu item. In some variations, the session record 149 may also identify information about the interaction, such as a type of the interaction (e.g., conversion versus non-conversion; search, navigation or viewing activity, etc.). In other variations, the order interface 120 can also identify contextual information as part of the session record 149. By way of example, the contextual information can include a time and/or day when the session was initiated, weather information at the location of the consumer and/or supplier, traffic information or identification of other events which may affect food delivery orders. The contextual information can be obtained from any one of multiple sources, including consumer or provider devices and/or third-party services.

In some examples, the order interface 120 detects the consumer's interaction 145 with the interactive menu 119. By way of example, the consumer's interaction 145 can include search, navigation and viewing activities. The order interface 120 can further detect selection input, which causes a menu item that the consumer was viewing or otherwise identified to be placed in a checkout queue. The consumer can complete an order request after selection of one or multiple menu items with submission of a corresponding completion input (e.g., consumer selects ‘checkout’ icon provided with the interactive menu 119). Once the user indicates the order session is complete, the order interface 120 generates an order request 147 that identifies each menu item that was selected by the consumer. The order interface 120 also updates the session record to, for example, identify select menu items of the order request as being converted.

When an order request 147 is placed with the order request data store 132, the matching component 140 can initiate a matching process to select a transport provider for the order request 147. The matching component 140 may match the order request 147 to an available transport provider based at least in part on the current location of individual providers with respect to the location of the supplier. In some variations, the matching component 140 may also match the order request 147 based on the desired arrival time for the provider at the location of the supplier. Thus, for example, the proximity of the transport provider may not necessarily be a decisive selection criterion for selecting a given transport provider.

In some variations, the monitoring component 162 can monitor processing of a completed order by a supplier to determine timing parameters 163 of individual orders as the orders are prepared and delivered. The monitoring component 162 can determine values for timing parameters 163 that reflect (i) an order preparation time of an order, (ii) a time to pickup of the completed order, indicating the length of time between when the order request 147 was completed by the consumer and when a service provider picked up the corresponding delivery order; and/or (iii) a time to deliver an order, meeting a duration between when a consumer completes an order request 147 and when the service provider completes the delivery of the corresponding delivery order to the consumer.

In examples, the monitoring component 162 determines the order preparation time and the time to pick up of the completed order, based on the current location of the provider, which may be recorded in the provider data store 134. The system 100 can select the service provider, and then monitor the current location of the service provider to approximate the time when the provider arrives at the location of the supplier, and/or when the service provider leaves the location of the supplier. The monitoring component 162 can also utilize input from the service provider (e.g., provided via the provider device interface 124) reflecting, for example, that the service provider is waiting at the supplier's location for a delivery order. The monitoring component 162 may also receive input from the supplier reflecting, for example, that the service provider has arrived and/or departed the location of the supplier with a delivery order. Still further, the monitoring component 162 can receive input from a beacon or other specialized resource at or near a location of the supplier, to detect proximity of designated individuals using proximity detection resources (e.g., via detection of Bluetooth signal transmission or Near Field Communication (NFC) signals).

With respect to parameters reflecting the time to deliver the orders, the input signals may be obtained from the location information of the service provider (e.g., as recorded by the provider data store 134). As an addition or variation, the input reflecting the time to deliver can be provided by the service provider (e.g., via the provider device interface 124), indicating drop-off of the delivery order. As another example, the input signals can include input from the consumer, reflecting the consumer's receipt of the delivery order.

In some examples, the monitoring component 162 can also obtain and record contextual information as feedback for completed order requests 147. The monitoring component 162 can obtain contextual information such as relating to weather, traffic, or other events from, for example, the consumer device 102 used to place an order and/or third-party sources.

The order profiling component 164 can identify profiling information for menu items from the order request store 132 and the user-interaction store 136. In examples, the order profiling component 164 can store menu item profiling information 165 as records of a corresponding menu profile data store 166. In some examples, the order profiling component 164 can reference individual orders with respective supplier records 125 of the supplier profile store 126 to determine supplemental information about the food items of each order. The menu item profiling information 165 can also include supplemental information, such as, a list of ingredients used in a respective food item that is selected for an order request. The supplemental information may also include information that identifies a manner in which each food item is prepared (e.g., blackened, sautéed, cooking temperature or time, type of cooking (e.g., flash-fry)), as well as other information, such as pairings between food items (e.g., selected side dish for an item).

In examples, the menu item profiling information 165 can also include timing parameters 163 for food items of individual order requests, based on, for example, feedback provided from the monitoring component 162. Still further, the menu item profiling information 165 that is obtained from completed order requests can include location information that identifies a delivery location of the completed order requests.

In variations, the menu item profiling information 165 can also include contextual information, which may be recorded with, for example, food items of completed orders. The contextual information can include weather information at the location of the consumer and/or supplier, traffic information or identification of other events which may affect food delivery orders.

### Interest Level Determinations

The IASS 170 can determine the interest level for prepared food items that are provided to consumers through publication of the interactive menus 119. The IASS 170 can analyze menu item profiling information 165 of the menu profile data store 166, over one or more prior time intervals (e.g., prior week or month), to make determinations with respect to an interest level of food types (e.g., genre of cuisine, food items that contain a particular characteristic, etc.) and/or individual food items. According to examples, the IASS 170 can generate interest level determinations 175 that include (i) identification of food item and/or types 177, (ii) interest values 179 for the respective food item and/or type, and/or (iii) location(s) of suppliers and/or consumers for the identified food items and/or types 181. The determined interest values 179 can be based on recorded activities (e.g., ordering activities, interactions with interactive menus) of users in a preceding duration of time. By way of example, the IASS 170 can determine interest values 179 for food items by genre of cuisine (e.g., type), category of food item (e.g., food items that contain a particular type of meat, such as Kobe beef), ingredient (e.g., pizza topping, type of spice), ingredient characteristic (e.g., farm-raised), preparation feature (e.g., serve chilled, thin crust, etc.) or other defined characteristic.

In some examples, the interest values 179 can correspond to a parametric value that reflects an expected amount of demand for a food item. For example, the interest value 179 may correlate to a number of items for a particular food item which are expected to be selected in completed order requests. As an alternative or variation, the interest 179 can correspond to a parametric value that reflects an amount of undersupply for a particular food item. The undersupply value can correlate to, for example, an amount of delay which a supplier of the food item is expected to incur (e.g., as compared to an average amongst food supplier) as a result of high demand for food items of the supplier.

The IASS 170 can include an interaction analysis component 172 which accesses data from the user-interaction store 136 in order to identify user-interactions of different types. The interaction analysis component 172 can process the different user-interactions to make one or more inferences regarding the interest level of users who interact with the interactive menu provided with their respective devices. In some examples, the interaction analysis component 172 analyzes user-interactions to detect interactions that are non-conversion type events. A non-conversion type event can correspond to a specific type of interaction of a user with a menu item (e.g., displaying a food item which the user can order), where the interaction results in the user not ordering the food item. By way of example, the specific type of interaction can correspond to a user searching for a specific food or menu item, and/or a user viewing a menu item. The interaction analysis component 172 may infer some level of interest from the user who interacts with the interactive menu in the manner stated. Additionally, the interaction analysis component 172 may infer some reason as to why the interaction did not lead to a conversion type event.

According to examples, the interaction analysis component 172 can process an aggregation of non-conversion type events on a basis that at least a portion of the non-conversion type events are probative of user-interest in a particular food item, but the interest level of the user in the food item was dampened by information presented on the corresponding menu item for the food item. By way of example, the information presented on the menu items which can dampen interest in a food item can include delivery time or price. Accordingly, in examples, the interaction analysis component 172 can analyze certain types of information which are determinable from the menu items which are subject to the non-conversion activities. For example, the interaction analysis component 172 can parse menu items to determine a food item identifier, a genre for the food item, and/or a price for the food item. The interaction analysis component 172 can associate a negative weight with a price for a food item based on a non-conversion type event. Based on an aggregation of non-conversion type events, the interaction analysis component 172 can make a determination that a menu item is over-priced. For example, the interaction analysis component 172 can determine that a food item of a particular supplier is over-priced, based on an aggregate value of non-conversion type events for a given food item provided by one supplier, as compared to an aggregate value of non-conversion type events from one or more suppliers who provide a same or similar food item.

Still further, in some examples, the interaction analysis component 172 can parse menu items of individual suppliers to determine published delivery times which appear or are otherwise provided with the supplier's menu items. The published delivery times can correspond to dynamic values which can be refreshed or updated based on input received from, for example, the supplier (e.g., via the supplier interface 130) or through monitoring of order requests 147 sent to the supplier (e.g., via the monitoring component 162). In such examples, a relatively high count of non-conversion type events for a particular food item, when combined with a longer than normal (or average) delivery time, can be indicative of an undersupplied food item. Specifically, the high count can indicate a high level of interest, with suppliers not having the capacity to meet the number of requests. Other factors that can weigh in favor of the determination that a particular food item is undersupplied include the same or similar food items reflecting high interest at other suppliers, and/or an increase in the interest value of the food item based on aggregate numbers of the items ordered.

The aggregation analysis component 174 can tally, for example, conversion type events, corresponding to food items which are selected by the user for an order request. The aggregation analysis component 174 can compare in an aggregate total of conversion type events for specific food items, with aggregate totals for the same food item in proceeding time intervals to determine an increase in interest level for the food item. The aggregation analysis component 174 can aggregate conversion hits for food types and events, as well as ingredients or other food preparation characteristics (e.g., type of cooking) based on the supplier information of the user-interactions store 136 and/or the menu item profiling information 165 of the menu profile data store 166.

As an addition or variation, the IASS 170 may implement trend logic 176 to detect trends with respect to the interest level of specific food items. The trend logic 176 may define a trend based on an increase in the interest level of a given food item or type, over a given time period, in accordance with predefined models and/or criteria that define the occurrence of a trend with respect to a given food item. The trend logic 176 can further be implemented to detect the onset of a trend with respect to the interest level of a given food item. For example, the trend logic 176 may compute a velocity or acceleration value for the interest level of a food item over time, to detect the onset of a possible trend with respect to the interest level of a food item or food type in a given population of users. In examples, a determined trend can be associated with a sub-region, based on the location of the consumers for the trending food item, as well as the supplier of the respective food items.

In some examples, the trend logic 176 can use a total number of available food types in the geographic region (e.g., number of restaurants or professional kitchens) to predict a change. The trend logic 176 can make an inference that a supplier that introduces a new food type near a given sub-region is or is not more likely to have their food items trend in the respective geographic region based on the number of food types that are offered in the geographic region.

In variations, the IASS 170 includes preparation time logic 178. The preparation time logic 178 can detect a variance in the preparation time of a defined food item over a preceding time interval as compared to an expected preparation time for the particular food item. In particular, the IASS 170 can implement the preparation time logic 178 to detect a specific food item, as prepared by a particular supplier or set of suppliers, for which the preparation time during the preceding time interval exceeded an expected preparation time. The expected preparation time can be determined from, for example, (i) an average time as measured over a longer prior duration of time, and/or (ii) food preparation time for the same or similar food items by suppliers in other geographic regions. Examples recognize that an increase in preparation time of a specific food item or food type (e.g., as provided by a given supplier or set of suppliers) can provide a probative marker of a food item or type that is, within a given sub-region, (i) undersupplied and/or (ii) of high or increasing interest.

In order to determine the food preparation time, the IASS 170 can utilize the timing parameters 163 associated with specific food items from one or multiple suppliers. In an implementation, the preparation time for a given food item of an order request can be approximated based on a difference between the time when a corresponding order request was received and a pickup time of the corresponding delivery order by a service provider. In variations, the preparation time can be based on a time when the supplier begins preparation of the food item and a pickup time of the corresponding delivery order by a service provider. Still further, the preparation time can be estimated from a delivery time for the food item of the corresponding order request. In this way, the preparation time for individual orders can be aggregated over the preceding time interval. The preparation time can be, for example, in the form of an average.

In some examples, the interest level for a food item or type can be expressed as a parametric value, such as a value that ranges between 0 and 1. For example, the interest level value 179 for a food item or type can correspond to a composite or weighted value that is based in part on parametric components determined from non-conversion type events, aggregations of conversion type events, and/or determinations of the preparation time for food items. The interest level value 179 can correlate to an estimated demand for a food item or type. For example, the interest level value 179 can correlate to an expected number of food items which were ordered in a given region, or which are expected to be ordered in an upcoming time interval. As an addition or alternative, the interest level value 179 can represent a measure of undersupply. The undersupply for a prior time interval can be estimated by, for example, a difference between a number of orders that were requested and a number of orders that could have been received. In some examples, the interest level value 179 can correlate to a metric of undersupply that is represented by a measure of delay with respect to delivery orders for a subject food item or type. The determination of delay can be based on, for example, a duration that is required to prepare and deliver a food item as compared to an average or predicted time for delivery orders of the supplier.

The IASS 170 can determine the interest level for food items and food types to be specific to geographic sub-regions and zones where users and/or suppliers are located. In examples, the IASS 170 can identify locations where consumers who have an interest in a food item are located, as well as locations where suppliers of those food items are located. The locations of consumers that interact with the service application can be identified and recorded, to associate food items of non-conversion type events or conversion type events (or order request) with respective locations. Similarly, the IASS 170 can record the locations of suppliers which provide the respective food items which are associated with interest levels.

In examples, the IASS 170 generates interest level determinations 175 for an interest level determination store 168. For example, the interest level determination store 168 can maintain the interest level determinations 175 of the IASS 170 for multiple time intervals (e.g., such as for each evening of a given week) and/or on a historical basis. In this way, the output data set of the IASS 170 can be updated and aggregated over time.

According to some examples, the system 100 includes one of more components that utilize interest level determinations 175 of the IASS 170. While examples provided below are described in the context that components that utilize the interest level determinations 175 of the IASS 170, in variations, the interest level determination 175 can be utilized by services that are external to the system 100. For example, the system 100 can include an API to enable access to at least some of the interest level determinations 175, which may be provided via the interest level determination store 168.

### Mapping

With reference to examples of FIG. 1, the system 100 includes a mapping component 180 to implement one or more mapping functions or modes, to generate a location-specific representations 182 of the interest level for select food items. In one implementation, the location-specific representations 182 can correspond to a map of a geographic region, where suppliers of food items of interest are identified. In variations, the location-specific representations 182 can include a gradient representation (e.g., heatmap) of the interest value in a food item or type, based on a distance or proximity from a given supplier of the food item of interest and/or from locations where consumers are located which have high interest for the food item. In other variations, the gradient heat map can be modeled to reflect a location supplier of a food item or type that is of high interest as being a source, while location(s) (e.g., aggregate location) of consumers of the food item or type of interest are sinks. Depending on implementation, the strength of the interest level for the food item or type can weigh or skew the gradient lines, to reflect locations where, for example, the food item or food type is undersupplied within the geographic region.

In other variations, the location-specific representations 182 can identify zones (e.g., a predefined area) where food items of a particular characteristic (e.g., genre, category, feature, etc.) are of relatively high interest as compared to other food items which are offered in the same geographic region. As an addition or variation, the IASS 170 identifies geographic zones where food items of a particular characteristic are undersupplied. In other variations, the IASS 170 can predict the interest level for food items and types within specific geographic sub-regions, based on the determined interest level for the food items and types in preceding time intervals in other geographic sub-regions. In predicting interest levels for food items and/or types, the IASS 170 can take into consideration trends, which may reflect, for example, acceleration of interest in a food item or type over preceding time intervals.

The mapping component 180 can publish one or more versions of location-specific representations 182, for a given time interval and geographic region, to different entities. The mapping component 180 can, for example, communicate a heat map 183 version of location-specific representations 182 to a supplier (via the supplier interface), to illustrate, for example, food items or types that are in demand or otherwise trending in the vicinity (e.g., within maximum range of delivery) of the supplier. As another example, a heat map can be communicated to a prospective supplier to illustrate a suitable location from which a particular type of food items can be made available via a delivery service provided by the system 100. Still further, the mapping component 180 can publish lists or maps (e.g., including heat maps) to consumers to increase consumers' knowledge and interest in food items which may be available in a given geographic region.

### Recommendation Engine

In some examples, the system 100 can also include a recommendation engine 184 which can generate recommendations for suppliers with respect to food items that are offered at a given supplier location. The recommendation engine 184 can receive an input signal that corresponds to the location of the supplier.

As an addition or variation, the recommendation engine 184 can predict, or otherwise forecasting a number of consumers that are expected to be present in a given geographic region. For example, the recommendation engine 184 can determine a number of consumers that are expected to travel from one part of a geographic region to another part of the geographic region, based on, for example, their past habits or practice. In such variations, the recommendations 189 can, for a given supplier, be based on a number of consumers that are expected to be near the location of the supplier (e.g., restaurant) during a certain time frame (e.g., dinner), as well as consumers who are located or otherwise live near (e.g., within delivery range) the given supplier.

In some examples, the recommendation engine 184 can also receive an input signal that identifies the type of food items the supplier provides (e.g., Italian), or specific food items or characteristics of food preparation which the supplier provides. For a given supplier, the recommendation engine 184 can utilize the interest level determinations 175 of the IASS 170 to determine, for a designated sub-region that includes the location of given supplier, a recommended set of food types or food items (“recommendations 189”) which are (i) undersupplied, (ii) of relatively high interest, and/or (iii) trending (e.g., increasing in popularity), or are at the onset of trending.

The recommendation engine 184 can implement comparison logic 185 to determine preparation information relating to how food items of the recommendations 189 can be prepared. The preparation information can, for example, identify ingredients of the food items of the recommendations, cooking ware and/or specialized cooking equipment (e.g., pizza over, ice bar, etc.) which may be needed to prepare the food items of the recommendation. The recommendation engine 184 can further obtain supplier food preparation information 187 from, for example, the supplier profile store 126. The supplier food preparation information 187 can identify the food items which are on the menu of the supplier, the ingredients of the food items, the cooking ware used to prepare the items, and any specialized cooking equipment which the supplier may have onsite, in preparing food items for the existing menu. The recommendation engine 184 may implement the comparison logic 185 to identify a degree of overlap between the existing food items on the menu of the supplier, and individual food items or food types identified by the recommendations. The overlap can include a score, for example, which reflects an amount of overlap in ingredients between the suppliers offered food items and individual food items of the recommendation 189. For example, if the ingredients used to prepare food items identified by a recommendation 189 have a significant amount of overlap with the food items of the supplier's existing menu, the score of the overlap can be relatively high, reflecting the ability of the supplier to offer food items of the recommendations 189 using many of the ingredients the supplier already has on-hand.

As an addition or variation, the overlap score can reflect a cost to the supplier for offering food items of the recommendations 189. For example, if the supplier has to purchase new ingredients, rather than a greater amount of existing ingredients, the cost may be higher for the supplier to prepare food items of the recommendation, and this increased cost can be inversely reflected by the overlap score.

The supplier food preparation information can also identify the supplier's cookware and/or specialized equipment. The amount of overlap with respect to cookware and equipment which the supplier has on hand at the supplier location, versus cookware and equipment which the supplier would need to prepare food items of the recommendation can also be reflected in the overlap score. For example, if the recommended food item requires a pizza oven which the supplier does not have, the omission of the pizza oven as expensive specialized equipment can drop the overlap score significantly, to reflect infeasibility on the part of the supplier to provide the food items of the recommendation.

According to some examples, the recommendation engine 184 can implement the comparison logic 185 to generate food items of the recommendation 189 for a given supplier, based on the location of the supplier and the feasibility for the supplier to offer the additional items. In such examples, the feasibility for the supplier to carry food items of the recommendations 189 can be reflected in quantitative metrics such as by the overlap score.

Still further, the recommendation engine 184 can generate forecast recommendations to facilitate daily or periodic operations of the supplier. In examples, the forecast recommendations can be specific to food type, and based on historical interest levels and/or trends. By way of example, a supplier can receive the recommendations as a planning mechanism.

In some variations, the recommendation engine 184 can generate consumer recommendations 191, which are communicated to the consumer devices 102 via the consumer device interface 110. The consumer recommendations 191 can identify, for example, one or more food items that are of relatively high interest, and/or trending (e.g., demand for orders is increasing), or are at the onset of trending (e.g., surge of orders for the food item is detected in a short time frame). The consumer recommendations can be based on, for example, the interest level determinations 175 of the IASS 170. In examples, the recommendation engine 184 can receive input that identifies a location of the requesting consumer. Based on the location of the requesting consumer, the recommendation engine 184 communicates a set of consumer recommendations 191 to the consumer device 102.

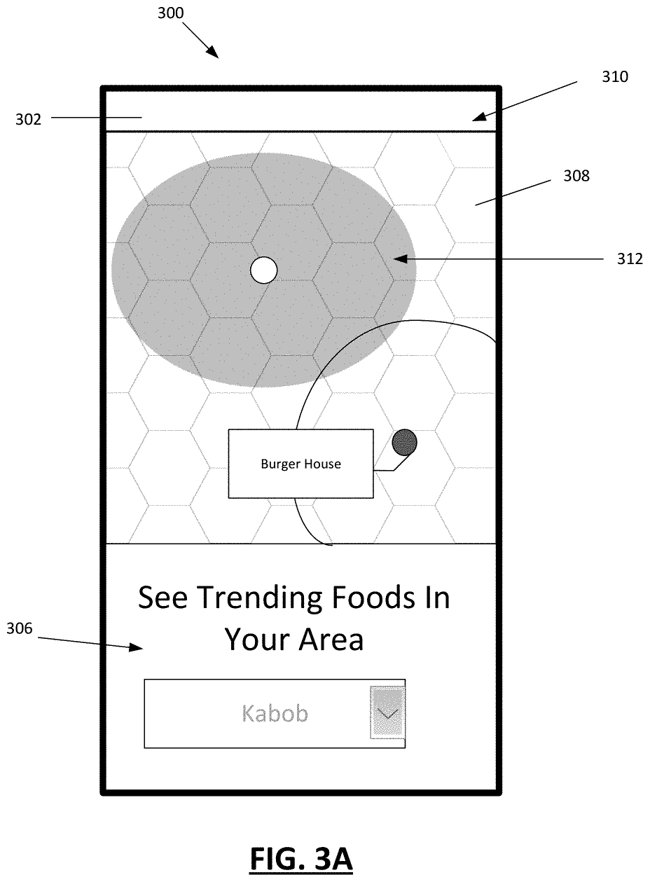

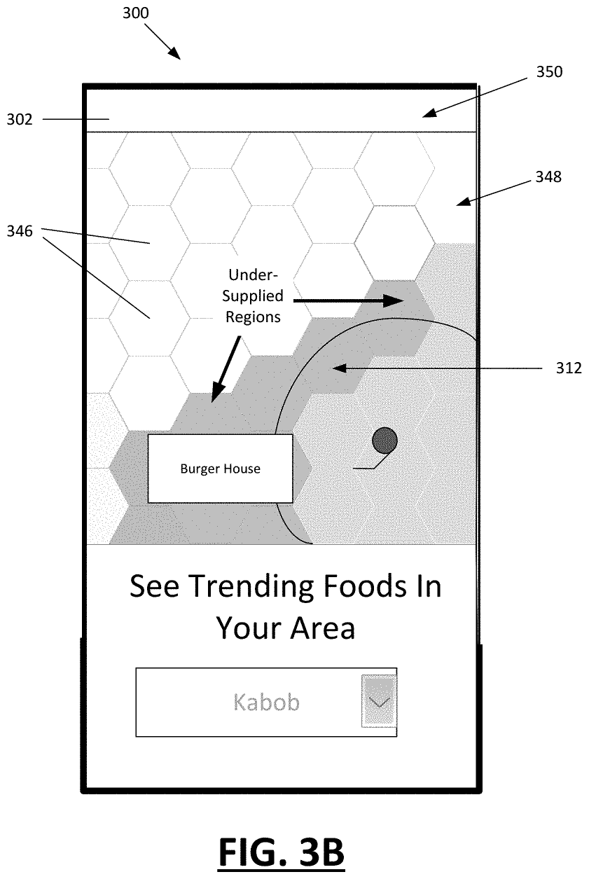

In some variations, the recommendations 189, 191 as generated for either of the supplier or consumer can be integrated, or otherwise indicated by, for example, the map output (e.g., heat map 183 of the mapping component 180). For example, the consumer recommendations 191 can be embodied by a map interface (e.g., see FIG. 3A and FIG. 3B) that identifies those food items or food types that are of greatest interest (e.g., most frequently ordered) or are trending. In this way, the consumer can tailor their respective order request 147 to a particular food item that is of greatest interest, or which is otherwise trending. Likewise, the supplier recommendations 189 can identify map content (e.g., heat map) or other content which identifies food items or type which the supplier may be willing to provide.

### Methodology

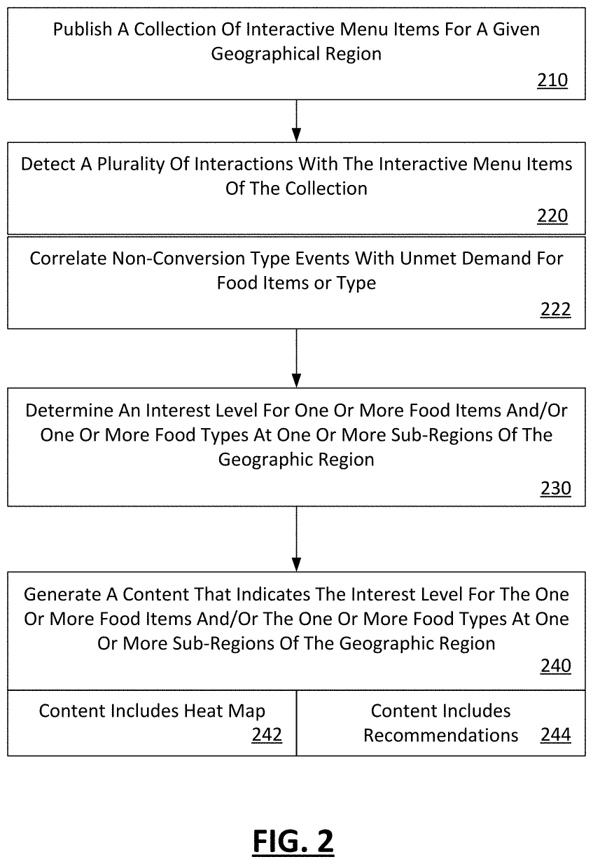

FIG. 2 illustrates an example method for determining interest levels for menu items amongst a population of users. In describing examples of FIG. 2, reference is made to elements of an example of FIG. 1 for the purpose of illustrating a suitable component for performing a step or sub-step being described.

With reference to an example of FIG. 2, the system 100 publishes a collection of interactive menu items to consumers of a given geographical region (210). The interactive menu items can be published through, for example, the service application 106 that runs on consumer devices 102. The menu items can each represent a food item which can be prepared by a particular supplier at a corresponding supplier location.

The system 100 can implement processes to detect interactions with the published interactive menu items (220). In examples, the detected interactions can include search activities, such as by consumers who search for food items using keywords that match to food items, suppliers or genre/category of food items. The detected interactions can also include navigation and/or viewing activities (e.g., the consumer selects menu item for viewing).

Still further, the detected interactions can include interactions from those users who are located at the location where a respective delivery order is received. As an addition or variation, the detected interactions can include interactions from other users who are not located where the delivery order is received, but are rather investigating the food offerings of the delivery service in another location that is away from their current location. The system 100 can also detect published delivery times and/or prices with menu items that are subject to such user interactions in order to make negative and positive inferences with respect to non-conversion type event and conversion type events, respectively. In some examples, the detected interactions can correspond to non-conversion type events, where food items that are indicated by the consumer's interactions are not selected for an order request by the consumer. For example, the published delivery time for menu items that are subject to a relatively large number of non-conversion type events may be inferred as being too long. Likewise, the published price for food items that are greater than similar food items for other suppliers may indicate the supplier has lost sales as a result of the food item being overpriced. Likewise, if the total number of non-conversion type events a supplier has is deemed to be less than what is typically experienced by other similar suppliers (e.g., a statistical deviation less than the average number of non-conversion type events), the system 100 may make the inference that the price of the food item is too low.

System 100 may further recognize instances when a supplier incurs a large number of non-conversion type events, either in general or with respect to a specific food item. The system can associate the large number of non-conversion type events to an indicator of unmet demand, particularly if the delivery time published with the menu items of the supplier were relatively larger than average for other suppliers in the same area (222). The indicator may further contribute to the determination when combined with other determinations, such as a determination that the delivery time for the particular supplier or food item exceeded the average published delivery times for other food items or suppliers.

In some examples, the system 100 can generate records to represent menu items that are subject to interactions of consumer. The records for the respective interactions can identify a location of the consumer who provided the interaction, as well as the menu or food item that was subject to the interaction. Still further, each record can reflect whether the corresponding interaction was a non-conversion type event, along with one or more indicators of the delivery time and/or price that was published with the respective menu item.

According to examples, the system 100 determines an interest level for one or more food items and/or one or more food types at one or more sub-regions of the geographic region (230). The determined interest level can be in the form of a parametric value of score (e.g., interest level value 179) and further associated with a menu item or supplier. As described with other examples, the determined interest level can correlate to an estimated demand for a food item or type, such as a number of food items which were ordered, or expected to be ordered, in a given region, during a past or upcoming time interval. As an addition or alternative, the determined interest level can represent a measure of undersupply for the associated food item or food type. The undersupply for a prior time interval can be estimated by, for example, a difference between a number of orders that were requested and a number of orders that could have been received.

In examples, the system 100 generates a content that indicates the interest level for the one or more food items and/or food types (240). In some examples, the content generated can be in form of a heat map 183, which may indicate a source of a food item (242). Depending on implementation, the heat map 183 may also indicate a location (e.g., in aggregate) of demand for a food item, and/or one or more distances that indicate a delivery range of the supplier.

In variations, the generated content can include one or more recommendations for suppliers (244). By way of example, the system 100 can generate a set of recommendations for a given supplier, where the recommendations identify alternative food items, or an alternative type of food item, based at least in part on the system 100 determining that there is adequate demand for the recommended food item at a location of the given supplier. Still further, in some examples, the system 100 may recommend food items which are deemed to be undersupplied, at least to a portion of the delivery range for the given supplier.

### Map User-Interface

FIG. 3A and FIG. 3B illustrate alternative map interface that indicates interest levels for food items or types in a given geographic region, according to one or more examples. Example map interfaces such as shown with examples of FIG. 3A and FIG. 3B may be implemented by, for example, a network computing system such as described with an example of FIG. 1.

With reference to an example of FIG. 3A, a map interface 310 is generated on a display 302 of a user device 300. The map interface 310 can depict a map 308 for a portion of a geographic region. In examples, the map interface 310 includes overlay content 312, which can represent a type of interest level for a particular food item or food type. For example, the map interface 310 can reflect gross demand (e.g., total number of orders), undersupplied food items (e.g., the number of orders that could be served exceeds those which respective suppliers can handle without delay) and trending food items (e.g., the total number of orders for a given food item is expected to increase). In some variations, the interest level can be determined in part from a delivery service area of one or more suppliers.

The overlay content 312 may be shaded, colored, or patterned to reflect a degree or type of interest level that exists for a given food item or food type. To illustrate, the overlay content 312 may be darkened to indicate, for example, sub-regions of the geographic region where the interest for the food item or type amongst the corresponding population of consumers is greatest. Features such as shade, color, and/or patterns can also mark the amount of interest level (e.g., total number of items ordered in a given time interval) that exists for the food item or type.

In some examples, the interest level depicted with the map interface 310 can be predictive of the interest that a food type or item can receive, such as in the form of a number of orders that a given food item receives, in a geographic sub-region or region, over a similar prior time interval. In variations, the interest level depicted with the map interface 310 can reflect a historical value or snap shot. As an addition or variation, the interest level depicted with the overlay content 312 or other aspect of the map interface 310 can indicate where a particular food item or type is undersupplied at depicted sub-regions of the larger geographic region. For example, the system 100 can make the determination that a quantity of consumers who, during a given time interval, are likely to order the particular food item or type exceeds the throughput for the suppliers to make the particular food item or type. In such examples, the degree or amount by which the system 100 determines the particular food item or type is undersupplied can be represented by shading, coloring or patterning of the overlay content 312.

Still further, in some examples, the map interface 310 can be used to depict sub-regions where a food item or type is trending. When a food item is trending, an aggregate number of orders that the food item or type receives over a given time period may increase over similar time periods in the past. Thus, when the food item is trending, the number of orders which the food item receives over time may generally increase. Shading, coloring, patterning or other visual markers may be depicted on the map content 308 to identify a location where food items are trending, as well as to a degree to which such food items or types of trending.

The map interface 310 may be provided with an input interface 306 to enable the viewer to select a food item or type. As an addition or alternative, the map interface 310 may identify a food item or food type to the viewer. In some examples, the viewer corresponds to a consumer, who views the map interface 310 to identify information about delivery orders in a given region (e.g., the consumer's home). For example, the map interface 310 can depict overlay content and/or other features to identify, or otherwise recommend, food items or food types to consumers who wish to tailor their respective orders to food items or type that are trending, or alternatively, of the greatest interest to the population of users.

In other examples, the viewer can correspond to a supplier (e.g., restaurant owner), who can view the map interface 310 to identify a food or food type which the supplier can offer for a delivery service, to match a food item or food type that has a relatively high-interest level. In one example, the supplier may correspond to a restaurant operator who views the overlay content 312 in order to select a food item or type to offer through the delivery service. The selection may be based on the map interface 310 indicating that the food type is likely to have a high-interest level to consumers who are located within the supplier's delivery range.

As another example, the overlay content 312 can identify a region where a particular food item or type of food is in high demand, relative to a location of the supplier. An existing supplier can, for example, select a food item or food type to offer through a delivery service of the system 100, in order to meet the demand for the particular food or food item. As another example, a prospective or new supplier may select a location within the given geographic region to operate based on a determination that the type of food items which the supplier intends to provide through the delivery service is in high demand at that location.

As another example, the map interface 310 can also indicate one or more existing sources (e.g., other suppliers or restaurants) which provide a food item or type that is of high interest. Still further, in other examples, the map interface 310 can identify zones on the map region which correspond to locations where a high-interest food item or type is not readily available for delivery service.

With reference to an example of FIG. 3B, a map interface 350 may alternatively be generated on the display 302 of the consumer device 300. In an example of FIG. 3B, the map interface 350 includes map content 348 with predefined sub-regions 346 that may be selected shaded, colored or patterned, to identify a type and/or magnitude of the interest level. For example, each pre-defined sub-region or zone can be shaded, colored or patterned to indicate that a selected food item (e.g., kabobs) is in high-demand, undersupplied or trending.

With reference to examples such as shown by FIG. 3A and FIG. 3B, the respective map interfaces 310, 350 can reflect historical demand. In variations, the map interfaces 310, 350 can reflect a prediction of demand for specific food items and food type in an upcoming time interval.

### Computer System

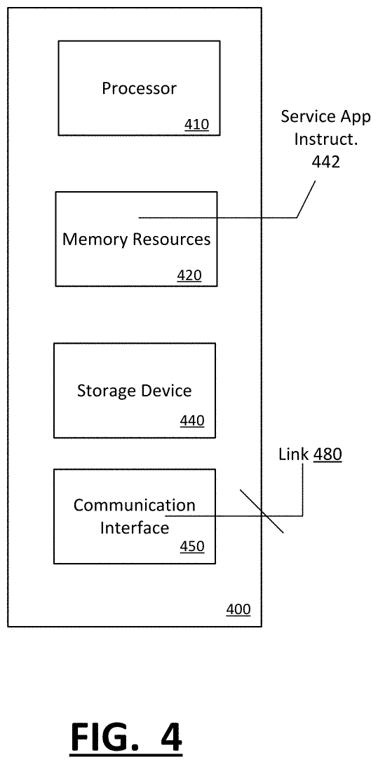

FIG. 4 illustrates a computer system on which one or more embodiments can be implemented. A computer system 400 can be implemented on, for example, a server or combination of servers. For example, the computer system 400 may be implemented as part of the of an example of FIG. 1. Likewise, the computer system 400 can implement a method such as described with an example of FIG. 2.

In one implementation, the computer system 400 includes processing resources 410, memory resources 420 (e.g., read-only memory (ROM) or random-access memory (RAM)), a storage device 440, and a communication interface 450. The computer system 400 includes at least one processor 410 for processing information stored in the main memory 420, such as provided by a random-access memory (RAM) or other dynamic storage device, for storing information and instructions which are executable by the processor 410. The main memory 420 also may be used for storing temporary variables or other intermediate information during execution of instructions to be executed by the processor 410. The computer system 400 may also include the memory resources 420 or other static storage device for storing static information and instructions for the processor 410. The storage device 440, such as a magnetic disk or optical disk, is provided for storing information and instructions.

The communication interface 450 enables the computer system 400 to communicate with one or more networks (e.g., cellular network) through use of the network link 480 (wireless or a wire). Using the network link 480, the computer system 400 can communicate with one or more computing devices, specialized devices and modules, and/or one or more servers. The executable instructions stored in the memory 420 can include instructions 442, to implement a network computing system such as described with an example of FIG. 1. The executable instructions stored in the memory 420 may also implement a method, such as described with an example of FIG. 2.

As such, examples described herein are related to the use of the computer system 400 for implementing the techniques described herein. According to an aspect, techniques are performed by the computer system 400 in response to the processor 410 executing one or more sequences of one or more instructions contained in the memory 420. Such instructions may be read into the memory 420 from another machine-readable medium, such as the storage device 440. Execution of the sequences of instructions contained in the memory 420 causes the processor 410 to perform the process steps described herein. In alternative implementations, hard-wired circuitry may be used in place of or in combination with software instructions to implement examples described herein. Thus, the examples described are not limited to any specific combination of hardware circuitry and software.

### User Device

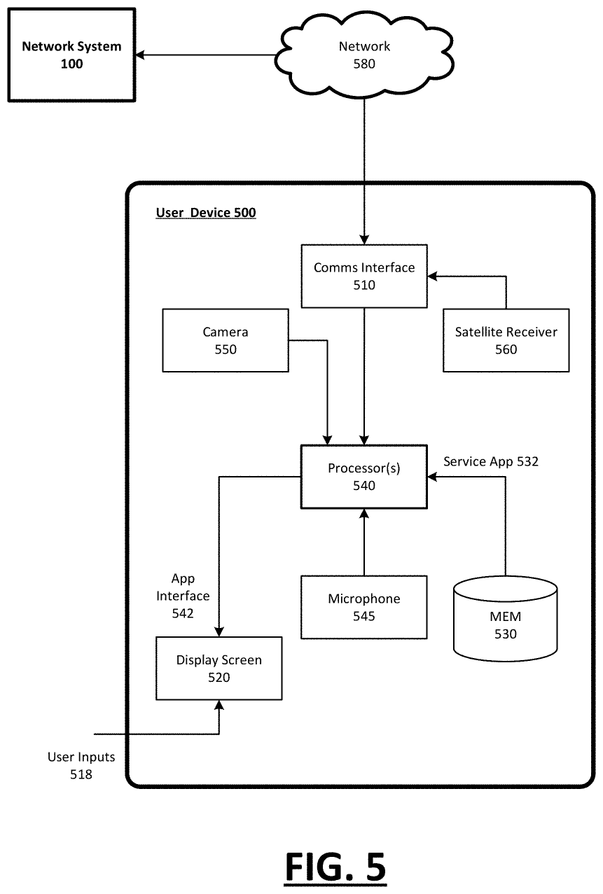

FIG. 5 is a block diagram illustrating an example user device for use with examples as described. In an example, a user device 500 may execute a designated service application for a network service implemented through a network computing system 100, such as described with an example of FIG. 1. In many implementations, a user device 500 can include a mobile computing device, such as a smartphone, tablet computer, laptop computer, VR or AR headset device, and the like. As such, the user device 500 can include typical telephony and/or tablet features such as a microphone 545, a camera 550, a satellite receiver 560, and a communication interface 510 to communicate with external entities using any number of wireless communication protocols. In certain aspects, the user device 500 can store a designated application (e.g., a service app 532) in a local memory 530. In variations, the memory 530 can store additional applications executable by one or more processors 540 of the user device 500, enabling access and interaction with one or more host servers over one or more networks 580.

In response to a user input 518 (e.g., search input), the service application 532 can interact with the user device 500 to display an application interface 542 on a display screen 520 of the user device 500. When the user device 500 is used as a consumer device, the application interface 542 can be used to display, for example, the interactive menu 119, and enable the consumer to make order requests from the network computing system 100.

In other examples, the user device 500 corresponds to the supplier terminal 142. The supplier terminal 142 can interact with the network computing system 100 to depict location-specific representations 182, such as a heat map 183. With reference to examples of FIG. 3A and FIG. 3B, the user device 500 can implement a service application or other programming to depict, for example, the map interface 310 or the map interface 350.

### CONCLUSION

Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is claimed is:

1. A network computing system comprising:
one or more processors;
a memory to store a set of instructions;
wherein the one or more processors access the instructions to:
publish a collection of interactive menu items for a geographical region, each menu item including one or multiple food items that can be prepared by a corresponding food preparation source of the geographical region;
detect a plurality of interactions with one or more menu items of the interactive menu items of the collection, wherein the plurality of interactions are by a population of users of the geographical region, and wherein each interaction is associated with a location of a respective user, one or more food items identified for selection by the interaction, and one or more food preparation sources selected by the interaction;
determine, based on at least a portion of the plurality of interactions, an interest level for one or more food items or one or more food types at one or more sub-regions of the geographic region, wherein the one or more sub-regions are based at least in part on the location of the user that is associated with each interaction of the portion of the plurality interactions; and
generate a content that indicates the interest level for the one or more food items or the one or more food types at one or more sub-regions of the geographic region.

2. The network computing system of claim 1, wherein the one or more processors determine the interest level for one or more food items, and generate the content to indicate the interest level for a food type or category of the one or more items.

3. The network computing system of claim 1, wherein the content includes a heat map.

4. The network computing system of claim 1, wherein the one or more processors access the instructions to:
determine a trend amongst the population of users with respect to the interest level for a particular food item or a food type based on the one or more food items identified by at least some of the plurality of interactions.

5. The network computing system of claim 4, wherein the one or more processors access the instructions to:
determine one or more sub-region of the geographic region to associate with the trend based on the location of the user that is associated with each of the at least some of the plurality of interactions.

6. The network computing system of claim 5, wherein the content includes a map that identifies a sub-region of the geographic region where users of the trend are located.

7. The network computing system of claim 1, wherein the one or more processors detect multiple types of interactions with the interactive menus of the collection, including a conversion type interaction in which the one or more food items identified for selection by the respective interaction are made part of an order request by a respective user, and a non-conversion type interaction in which the one or more food items identified for selection by the respective interaction are a subject of a search or viewing operation by the respective user.

8. The network computing system of claim 7, wherein the one or more processors determine a trend amongst the population of users with respect to the interest level for a particular food item or a food type based on aggregating a number of non-conversion interactions for the respective food item or food type in a given time period.

9. The network computing system of claim 7, wherein the one or more processors determine the trend by weighing the plurality of interactions by type, with at least some non-conversion type interactions having a greatest weight in determining a potential trend.

10. The network computing system of claim 1, wherein the content includes a map that identifies a sub-region of the geographic region where a food item or food type is undersupplied based on a determined interest level for the food item or food type by users that have the associated location within that sub-region.

11. The network computing system of claim 1, wherein the content identifies a set of food items that are recommended to a supplier based on a location of the supplier.

12. The network computing system of claim 11, wherein the recommended set of food items are of a same food type.

13. The network computing system of claim 11, wherein the food preparation source is associated with a first food type, and wherein the recommended set of menu items are for food items of a second type, wherein the first food type is associated with a first origin and the second food type is associated with a second origin.

14. The network computing system of claim 13, wherein the one or more processors recommend the set of menu items based at least in part on a determination that the supplier that receives the set of recommended food items can utilize a common set of ingredients to prepare food items of the first food type and food items of the second food type.

15. The network computing system of claim 1, wherein the one or more processors publish the collection of interactive menu items to include an indication of a delivery time.

16. The network computing system of claim 15, wherein the one or more processors determine that a given food item or food type is undersupplied in at least a sub-region of the given geographic region, based at least in part on the indication of delivery time published on a respective menu item or set of menu items for the given food item or given food type.

17. The network computing system of claim 16, wherein the one or more processors:
detect a number of non-conversion type interactions for the given food item or given food type from consumers that are located in the given geographic region; and
determine that a given food item or food type is undersupplied in at least a sub-region of the given geographic region, based at least in part on the number of non-conversion type interactions.

18. The network computing system of claim 18, wherein the one or more processors generate the content to identify the given food item or given food type and the sub-region where the given food item or food type is undersupplied.

19. A method for providing interactive menus, the method being implemented by one or more processors of a network computing system and comprising:
publishing a collection of interactive menu items for a geographical region, each menu item including one or multiple food items that can be prepared by a corresponding food preparation source of the geographical region;
detecting a plurality of interactions with one or more menu items of the interactive menu items of the collection, wherein the plurality of interactions are by a population of users of the geographical region, and each interaction is associated with a location of a respective user, one or more food items identified for selection by the interaction, and one or more food preparation sources selected by the interaction;
determining, based on at least a portion of the plurality of interactions, an interest level for one or more food items or one or more food types at one or more sub-regions of the geographic region, wherein the one or more sub-regions are based at least in part on the location of the user that is associated with each interaction of the portion of the plurality interactions; and
generating a content that indicates the interest level for the one or more food items and/or the one or more food types at one or more sub-regions of the geographic region.

20. A non-transitory computer-readable medium that stores instructions, which when executed by one or more processors of a network computing system, cause the network computing system to perform operations that include:
publishing a collection of interactive menu items for a geographical region, each menu item including one or multiple food items that can be prepared by a corresponding food preparation source of the geographical region;
detecting a plurality of interactions with one or more menu items of the interactive menu items of the collection, wherein the plurality of interactions are by a population of users of the geographical region, and wherein each interaction is associated with a location of a respective user, one or more food items identified for selection by the interaction, and one or more food preparation sources selected by the interaction;
determining, based on at least a portion of the plurality of interactions, an interest level for one or more food items or one or more food types at one or more sub-regions of the geographic region, wherein the one or more sub-regions are based at least in part on the location of the user that is associated with each interaction of the portion of the plurality interactions; and
generating a content that indicates the interest level for the one or more food items or the one or more food types at one or more sub-regions of the geographic region.
